(19) United States
(12) Patent Application Publication
(10) Pub. No.: US 2020/0124503 A1
(43) Pub. Date: Apr. 23, 2020

(54) METHODS, SYSTEMS, AND APPARATUSES FOR MEASURING CONCENTRATION OF GASES

(71) Applicant: Honeywell International Inc., Morris Plains, NJ (US)

(72) Inventors: Takashi YAMAGUCHI, Lake Forest, IL (US); Jeyoung JIN, Lincolnshire, IL (US); Daniel Jerzy PASKA, Carol Stream, IL (US); Venus DANTAS, Arlington Heights, IL (US)

(21) Appl. No.: 16/165,410

(22) Filed: Oct. 19, 2018

(51) Int. Cl. G01N 1/22; G01N 21/78

(52) U.S. Cl. CPC G01N 1/2208; G01N 2021/7759; G01N 21/783

(57) ABSTRACT

Various embodiments described herein, relates to a filter-less particle separation unit (FLPS) for a gas monitoring system. The filter-less particle separation unit includes, an inlet that defines an annular flow passage to facilitate an inflow of a fluid in the FLPS. In this regard, the annular flow passage between a first end and a second end of the inlet, defines an acceleration nozzle that is operable to accelerate the inflow, and eject the fluid at a defined volumetric flow rate. The FLPS further includes, a particle separating zone having a cavity of a defined form factor. The particle separation zone is operable to separate any particulate material that may be present in the fluid. Further, the FLPS includes an outlet operable to facilitate an outflow of filtered fluid to an input port of the gas monitoring system that measures a concentration of a reactive gas present in the fluid.

### TECHNOLOGICAL FIELD

Exemplary embodiments of the present disclosure relate generally to techniques for measuring concentration of a target gas in a fluid and, more particularly, to methods, systems, and apparatuses that provide filtered fluid using a filter-less particle separator, to measure the concentration of the target gas in the fluid.

### BACKGROUND

Usually, to protect workers against potential exposure to toxic and hazardous gases, gas monitoring systems are commonly installed in workplaces and other premises. Gas monitoring systems, typically, are used in industry for monitoring concertation of various gases, present in a sample or in working environment. Such gas monitoring systems are often commonly referred as gas analyzers or gas detectors or gas sensors, and/or the like.

Reactive or sticky gases are gases that generally have high chemical activity and are easily sorbed (adsorbed and/or absorbed) by exposed surfaces of the gas monitoring systems. Some examples of sticky or reactive gases include, but are not limited to Di-Isocyanate, Hydrazine, Sulfuric Acid, Hydrogen Iodide, Hydrogen Peroxide, Ozone etc. However, due to presence of dust particles in the sample or the environment, these reactive or sticky gases have a greater tendency to be depleted from a gas sample (for example, by exposed surfaces of the gas monitoring systems). Such depletion leads to inaccurate measurement of the concentration of the reactive gases by the gas monitoring systems.

Applicant has identified a number of deficiencies and problems associated with conventional methods of measuring concentration of gas by the gas monitoring systems. Through applied effort, ingenuity, and innovation, many of these identified problems have been solved by developing solutions that are included in embodiments of the present disclosure, many examples of which are described in detail herein.

### SUMMARY

In accordance with various embodiments described herein, a filter-less particle separation unit for a gas monitoring system is described. In this regard, the filter-less particle separating unit includes an inlet having a first end and a second end that defines an annular flow passage. The annular flow passage is operable to facilitate an inflow of a fluid. The annular flow passage defines an acceleration nozzle between the first end and the second end that is operable to accelerate the inflow and eject the fluid at a defined volumetric flow rate. The filter-less particle separating unit further includes a particle separation zone, extending outwardly from the acceleration nozzle. In an aspect, the particle separation zone comprises at least one cavity having a defined form factor. The filter-less particle separating unit further comprises an outlet, extending outwardly from one end of the particle separation zone. The outlet is operable to facilitate an outflow of filtered fluid to an input port of the gas monitoring system that measures a concentration of a reactive gas present in the fluid.

According to one example embodiment, a fluid monitoring system is described. The fluid monitoring system includes a filter-less particle separation unit having an inlet that is operable to facilitate an inflow of fluid including a target gas. In this regard, the filter-less particle separation unit also includes a particle separating zone including at least one cavity having a defined form factor. The filter-less particle separation unit also includes an outlet, that is operable to outflow filtered fluid including the target gas. In accordance with said example embodiment, the fluid monitoring system also includes a fluid monitoring chamber that is configured to measure a concentration of the target gas that is inflowed from the outlet into the fluid monitoring chamber.

In an aspect, according to said example embodiment, the target gas is a reactive gas and the filter-less particle separating unit is operable to separate the particulate material from the fluid based on virtual impaction using one of a virtual impactor or a vacuum venturi ejector.

In an aspect, according to said example embodiment, the inlet of the filter-less particle separating unit includes a first end and a second end defining an annular flow passage. The annular passage, in this regard, between the first end and the second end defines an acceleration nozzle. The acceleration nozzle, in accordance with various embodiments described herein, is operable to: (a) provide an acceleration to the inflow of the fluid in the annular flow passage and (b) eject out the fluid within a defined range of volumetric flow rate.

In accordance with said example embodiment, the at least one cavity of the particle separation zone is operable to generate a self-cleaning stream pattern of the fluid to separate particulate material present in the fluid based on at least, an inertia and size of the particulate material.

In an aspect, according to said embodiment, the filter-less particle separation unit may further include a collection probe that is operable to collect particulate material separated from the fluid in the particle separation zone. In another aspect, according to said embodiment, the particle separation zone separates the particulate material from the fluid based on one of: virtual impaction and a vacuum venturi ejection. In accordance with an example embodiment, a method for measuring concentration of a target gas in a fluid filtered using a filter-less particle separation unit is described. The method includes receiving, via an input port of a gas monitoring device and through an outlet of the filter-less particle separating device, an inflow of filtered fluid including the target gas. The method further includes determining, by a processing unit, a rate of change of color of a media element of the gas monitoring device, upon exposure of the media element to the filtered fluid including the target gas. The method further includes measuring, by the processing unit, a concentration of the target gas. In this regard, the concentration of the target gas is measured based on the rate of change of color of the media element of the gas monitoring device.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 schematically depicts a diagram of a filter-less particle separation unit for a fluid monitoring device, in accordance with some example embodiments described herein.

FIG. 2 schematically depicts a block diagram of a fluid monitoring system, in accordance with some example embodiments described herein.

FIG. 3 illustrates a diagram depicting internal and external structure of a filter-less fluid monitoring system, in accordance with some example embodiments described herein.

FIG. 4 illustrates a diagram representing a perspective view of a particle separation zone of a filter-less fluid monitoring system and a simulation view representing a self-cleaning stream pattern of fluid in the particle separation zone, in accordance with an embodiment described herein.

FIG. 5 illustrates a perspective view of a gas detector and an assembly of the gas detector with a virtual impaction based filter-less particle separation unit, in accordance with an embodiment described herein.

FIGS. 6A and 6B illustrate multiple perspective views of the fluid monitoring chamber assembled with the virtual impaction based filter-less particle separation unit, in accordance with an embodiment described herein.

FIG. 6C illustrates a side view of the fluid monitoring chamber assembled with the virtual impaction based filter-less particle separation unit, in accordance with an embodiment described herein

FIG. 6D illustrates a top view of the fluid monitoring chamber assembled with the virtual impaction based filter-less particle separation unit, in accordance with an embodiment described herein, in accordance with some example embodiments described herein.

FIG. 7 schematically depicts a diagram of a vacuum venturi ejector based filter-less particle separation unit for a fluid monitoring device, in accordance with an example embodiment described herein.

FIGS. 8A and 8B illustrate multiple perspective views of the vacuum venturi based filter-less particle separation unit assembled with the fluid monitoring chamber, in accordance with some example embodiments described herein.

FIG. 8C illustrates a side view of the vacuum venturi based filter-less particle separation unit assembled with the fluid monitoring chamber, in accordance with some example embodiments described herein.

FIG. 8D illustrates a top view of the vacuum venturi based filter-less particle separation unit assembled with the fluid monitoring chamber, in accordance with some example embodiments described herein.

FIG. 9 illustrates a flow diagram depicting a flow of fluid, in a gas monitoring system, for measuring a concentration of a target gas, in accordance with an example embodiment described herein.

FIG. 10 illustrates a flowchart describing a method of monitoring concentration of target gas, in accordance with some example embodiments described herein.

FIG. 11 illustrates a flowchart describing a method of monitoring concentration of target gas based on determining a rate of change in color of a media element, in accordance with some example embodiments described herein.

FIG. 12 graphically illustrates a comparison of response measured by a gas detector used with and without a filter, in accordance with some example embodiments described herein.

FIG. 13 graphically illustrates sample results indicating responses measured by a gas detector used along with different types of filtering units, in accordance with some example embodiments described herein.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout. Terminology used in this patent is not meant to be limiting insofar as devices described herein, or portions thereof, may be attached or utilized in other orientations

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment)

The word “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The detection of hazardous gases is critical in certain industrial environments, such as a clean room environment for manufacturing semiconductors and microprocessors, or paint and chemical manufacturing industries, fuel producing industries, and/or the like. For example, in the paint manufacturing industry, reactive gases, such as di-isocyanate, exist in the environment. Similarly, in jet fuel producing sites reactive gas, such as Hydrazine, is often released and needs to be monitored by the gas monitoring systems installed at such sites.

Typically, industrial toxic gas monitoring systems are required to be sensitive to gases at parts per billion (ppb) level. Existing gas monitoring systems, however, often provide inaccurate measurement of gas concentration for the reactive gases when operated in industrial environments.

In some examples, gas monitoring systems are inaccurate in industrial environments having particulate materials (e.g., dust particles). Indeed, particulate materials are understood to cause functional failures of various components of the gas monitoring systems. For instance, in some applications, the particulate materials cause contamination of optical units of the gas monitoring systems, such as gas detectors that contribute to inaccuracy in gas concentration measurement. These problems are increased, in some examples, when the reactive gases are to be measured by the gas detectors, because the use of ‘filter based’ particulate material separators to remove the particulate material are ineffective given that filters are generally known to absorb reactive gases.

Various exemplary embodiments described herein illustrate techniques for separating particulate materials from a fluid so as to provide the fluid in a filtered form to a fluid monitoring chamber, for example a gas detector, of a fluid monitoring system that measures a concentration of a reactive gas present in the fluid. In this regard, a filter-less particle separation unit for the fluid monitoring chamber of the fluid monitoring system is described herein in accordance with various example embodiments.

The example filter-less particle separation unit includes, but is not limited to: an inlet that is operable to facilitate an inflow of a fluid, a particle separation zone that is operable to separate particulate material from the fluid inflow, and an outlet that is operable to outflow filtered fluid to a fluid monitoring chamber of the fluid monitoring system. To this extent, the example filter-less particle separation unit is devoid of any filter membrane or filter media. According to some example embodiments described herein, the inlet of the filter-less particle separation unit includes a first end and a second end that defines an annular flow passage which is operable to facilitate an inflow of the fluid in the particle separation unit. To this extent, the annular flow passage between the first end and the second end of the inlet defines an acceleration nozzle that is operable to accelerate the inflow of the fluid and eject the fluid into a particle separation zone at a defined volumetric flow rate. In this regard and in accordance with various example embodiments described herein, the particle separating zone of the filter-less particle separation unit includes at least one cavity of a defined form factor. In this example aspect, the at least one cavity, because of its form factor and geometry, is operable to generate a self-cleaning stream pattern of the fluid and separate out particulate material from the fluid.

In some examples, the outlet of the filter-less particle separation unit is configured to be in fluid communication, for example by through a mechanical engagement, to an input port of the fluid monitoring chamber, thereby facilitating an inflow of the filtered fluid (i.e. fluid after separating the particulate material) into a chamber of the gas detector. Accordingly, the gas detector receives a filtered form of the fluid (i.e. fluid with little to no particulate material) from the filter-less particle separation unit.

For example, in accordance with one example embodiment, the filtered fluid may refer to a state of fluid when more than 50% of a particulate material of a defined size that is originally present in the fluid (i.e. before particle separation) is separated out. In another example embodiment, the filtered fluid may refer to a state of the fluid when from about 50% to about 95% of the particulate material originally present in the fluid is separated out by the filter-less particle separating unit. In another example embodiment, the filtered fluid may refer to a state of fluid achieved after removing 100% of the particulate material of size within a range from about 5 micrometers to about 6 micrometers, by the filter-less particle separating unit. In another example embodiment, the filtered fluid may refer to a state of fluid achieved after separating from about 50% to about 95% of a particulate material of size from about 2 micrometers to about 3 micrometers. In other examples, the filtered fluid may refer to a state of fluid achieved after separating out all or substantially all of the particulate material.

Generally, and in some examples due to prolonged exposure of components of the gas detectors to particulate materials, such as dust particles, present in the fluid inflowed for treatment decreases an operating life-cycle of the gas detectors. For example, often dust particles present in the inflowed fluid for treatment causes malfunctioning of various components, for instance, an optical or a sensing circuitry, within gas detectors. By way of various example implementations of the embodiments described herein, providing filtered fluid into the gas detectors for measuring the concentration of gases increases an operating life cycle of the gas detectors.

Moreover, various example embodiments described herein increase, in some examples, an accuracy of the gas detectors, particularly for monitoring and detecting the reactive gases. In this aspect, as the filter-less particle separation unit is devoid of any filtering membrane or a filtering material, the fluid inflowed into the particle separation unit is outflowed as filtered fluid, with little to no losses of the reactive gases. Various embodiments described herein, also improve, in some examples, operational efficiency of gas detectors, as the filter-less particle separation unit provides the filtered fluid to the gas detectors without reducing or substantially reducing the concentration of the reactive gas present in the fluid that may otherwise had been lost during filtering due to absorption or adsorption of the reactive gas with filtering elements present in conventional particle separating devices.

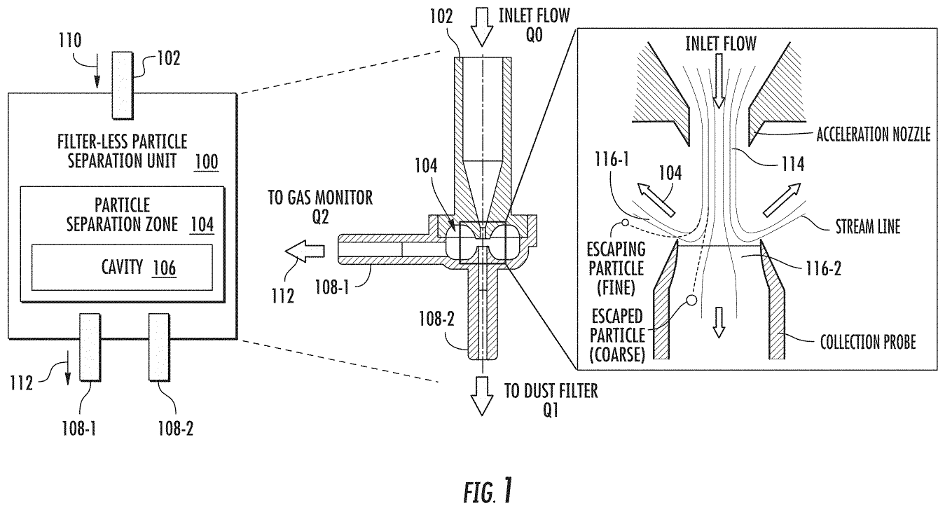

FIG. 1 schematically depicts a diagram of a filter-less particle separation unit (FLPS) 100 for a fluid monitoring device in accordance with some example embodiments described herein. In some example embodiments, the FLPS 100 may comprise: an inlet 102, a particle separating zone 104 including at least one cavity 106, and one or more outlets 108-1 and 108-2.

The inlet 102, in accordance with various example embodiments described herein, is operable to facilitate an inflow of a fluid 110 into the particle separating zone 104 for treatment, such as the removal of dust particles, of the fluid. The fluid described herein, may correspond to a gas sample including mixtures of gases, or aerosols, liquefied gas, compressed gas, liquid solution, and/or the like. According to an example embodiment, the fluid may correspond to an air sample present in an operating environment such as an industrial environment where the fluid monitoring device may be installed. The outlets 108-1 and 108-2 respectively may be operable to outflow portions of the fluid upon treatment. In this aspect and in an example embodiment, the outlet 108-1 may be a primary outlet that is operable to be in fluid communication with a fluid monitoring system that measures concentration of a gas present in a sample, for example a gas detector (not shown). In another example embodiment, the outlet 108-1 may be a primary outlet that is operable to be mechanically engaged to the fluid monitoring system that measures concentration of a gas present in a sample That is, and in some examples, the FLPS 100 may be an add-on or additional structure that is used in conjunction with a fluid monitoring system or, in some examples, may be an integral component of the fluid monitoring system.

The particle separating zone 104, in accordance with some example embodiments, is operable to separate out particulate material from the fluid 110 inflowed into the particle separating zone 104 based on at least, an inertia and size of the particulate material present in the fluid 110. In this regard and in accordance with various example embodiments described herein, the particle separating zone 104 is operable to separate the particulate material from the fluid based on virtual impaction using some components of virtual impactor or vacuum venturi ejector. In this regard, in accordance with various example embodiments described herein, the particle separating zone 104 is operable to separate the particulate material from the fluid based on one of virtual impaction or vacuum venturi ejection. In accordance with said example embodiments, the fluid may include one or more reactive gases, for example, but not limited to Di-Isocyanate, Hydrazine, Sulfuric Acid, Hydrogen Iodide, Hydrogen Peroxide, Ozone and/or the like. Accordingly, the outlet 108-1 may outflow the fluid 110 in filtered form, referred as filtered fluid 112, hereinafter throughout the description.

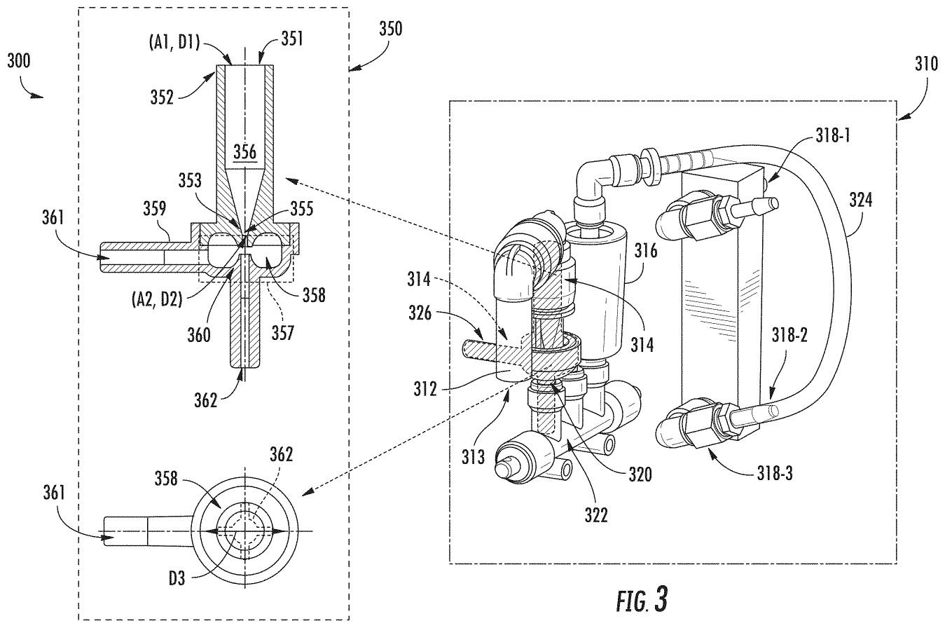

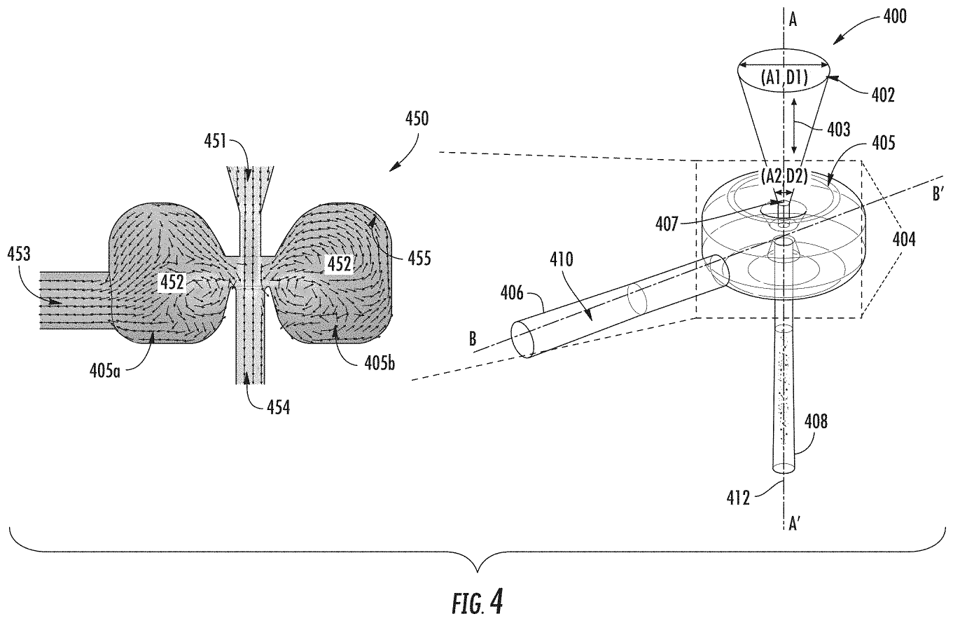

In accordance with said example embodiments, the cavity 106 of the particle separating zone 104 may be of a defined form factor, such as a doughnut shaped cavity, which extends outwardly in a direction perpendicular to the inlet 102. The cavity 106 may be defined such that it extends out from a distal end 114 of the inlet 102 and may protrude towards opening ends 116-1 and 116-2 of one or more of the outlets 108-1 and 108-2 respectively. In this regard, the cavity 106, in accordance with various example embodiments described herein, is operable to generate a self-cleaning stream pattern of the fluid inflowed and ejected out by the inlet. The self-cleaning stream pattern of the fluid generated by geometry or form factor of the cavity 106 is such that, the fluid circulates and flows inside the cavity 106 with negligible deposition of particulate material present in the fluid on an internal surface of the cavity 106. Further, as the self-cleaning stream pattern of the fluid circulates inside the cavity 106, the particulate material present in the fluid is separated out from the fluid based on at least an inertia and size of the particulate material present in the fluid. Accordingly, the filtered fluid is outflowed, via the outlet 108-1, into an input port of the gas detector. Further details related to structure and operations of the filter-less particle separation unit are described hereinafter in reference to FIGS. 3 and 4.

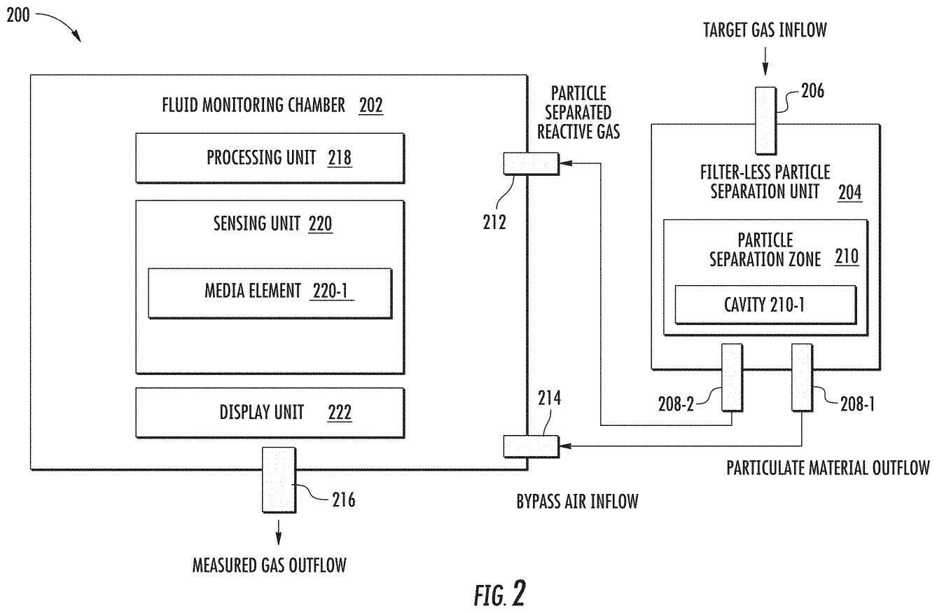

FIG. 2 schematically depicts a block diagram of a fluid monitoring system 200 in accordance with some example embodiments described herein. In accordance with an example embodiment, the fluid monitoring system 200 comprises a fluid monitoring chamber 202 and a filter-less particle separation unit (FLPS) 204. In this regard, the FLPS 204 may include an inlet 206 and at least two outlets 208-1 and 208-2 respectively.

The FLPS 204, in an example embodiment, includes a particle separation zone 210 including at least one cavity 210-1 of a defined form factor. Illustratively and in accordance with said embodiment, the fluid monitoring chamber 202 may include an input port 212, a by-pass flow input port 214, and an output port 216. In accordance with various example embodiments described herein, the inlet 206 of the FLPS 204 may be operable to facilitate an inflow of the fluid that includes the reactive or target gas. In this regard and in accordance with an example embodiment, the FLPS 204 is be configured to filter the fluid from particulate material that may be present in the fluid that inflows into the FLPS 204 through the inlet 206. The particle separation unit 210, according to said example embodiments, is operable to separate out the particulate material from the fluid and provide fluid in filtered form to the fluid monitoring chamber 202, via the outlet 208-2 of the FLPS 204. In this regard and in accordance with said example embodiments, the at least one cavity 210-1 of the FLPS 204 is operable to generate a self-cleaning stream pattern of the fluid at a defined volumetric rate to separate out the particulate material from the fluid. Accordingly, in accordance with said example embodiments, the outlet 208-2 is operable to outflow the filtered fluid from the particle separating zone 210 to the input port 212 of the fluid monitoring chamber 202.

The fluid monitoring chamber 202 may also include a processing unit 218, a sensing unit 220, and a display unit 222. As illustrated, the sensing unit 220 may also include a media element 220-1. In accordance with said example embodiments, the input port 212 of the fluid monitoring chamber 202 is configured to be in fluid communication, for example through a mechanical engagement, to the outlet 208-2 of the FLPS 204 to facilitate inflow of the filtered fluid from the FLPS 204 into a sub-chamber, for example an optics block chamber, of the fluid monitoring chamber 202. Further, the by-pass port 214 of the fluid monitoring chamber 202 may be configured to be in fluid communication, for example via a mechanical engagement, with another outlet 208-1 of the FLPS 204 to facilitate a by-pass fluid flow. In some examples, the by-pass fluid flow is air-flow left out after collection of the particulate material separated from the fluid.

In accordance with various example embodiments described herein, one or more of the sensing unit 220, including the media element 220-1, and the display unit 222 may be communicatively coupled to the processing unit 218 of the fluid monitoring chamber 202. In accordance with some example embodiments, the sensing unit 220 may further include, an optical sensor and an optical source. In this regard and in accordance with some example embodiments, the fluid monitoring chamber 202 of FIG. 2 may additionally include one or more processors (not shown herein), such as Central Processing Units (CPUs), Application Specific Integrated Circuits (ASICs), and/or Field Programmable Gate Arrays (FPGAs), a memory controller, memory, which may include software, and other components that are not shown for brevity, such as busses, etc. In an embodiment, the fluid monitoring chamber 202 may also include a communication circuitry (not shown) communicatively coupled to the processing unit 218.

According to said example embodiments, the sensing unit 220 of the fluid monitoring chamber 202 may be configured to sense a target gas present in the filtered fluid that may inflow into the fluid monitoring chamber 202 via the input port 212. For instance, the fluid monitoring chamber 202 may be configured to measure a concentration of the reactive gas from the fluid inflowed into the fluid monitoring chamber 202 by the FLPS 204. In this regard and according to one example embodiment, the media element 220-1 of the sensing unit may be operable to change its color, upon exposure of a surface of the media element to the target gas present in the filtered fluid that may be inflowed into the fluid monitoring chamber 202. The media element 220-1, in accordance with various example embodiments described herein, may be a tape or a chemically coated substrate, for instance, a chemcassette tape or chemically impregnated tapes, chemically impregnated films, chemically impregnated substrates and/or the like. In one example embodiment, the fluid monitoring chamber 202 may correspond to a tape-based gas detector and the media element 220-1 may be a chemically coated tape.

According to some example embodiments described herein, the sensing unit 220 may further include an optical unit operable to identify a change in color of the media element 220-1. The change in color of the media element 220-1 may occur upon exposure to the target gas present in the fluid. In accordance to said example embodiments, the optical unit may include an optical sensor and an optical source. In this regard, the optical source may be configured to project light rays of within a defined wavelength range on the media element 220-1 and the optical sensor may be configured to sense a reflection and/or transmission of the light rays, from the media element 220-1. The optical sensor may also be configured to determine wavelength associated with the reflection and/or transmission of the light rays sensed by the optical sensor.

In accordance with various example embodiments described herein, the optical source may include one or more light emitting diodes (LED). In this regard and in one embodiment, the one or more LEDs may be wide band LEDs operable to emit light of a defined intensity and within a defined wavelength range. In accordance with some embodiments, the optical sensor may include one or more narrow band light sensors that may be operable to detect light of different range of wavelengths, for instance, intensity ranging from about 560 mcd to about 2240 mcd, or more preferably from about 600 mcd to about 2100 mcd, or even more preferably from about 650 mcd to about 2000 mcd and wavelengths ranging from about 470 nm to about 630 nm, or more preferably within a range from about 490 nm to about 600 nm.

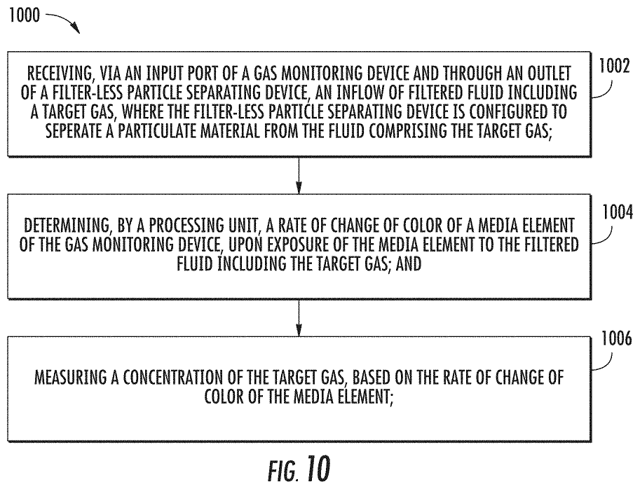

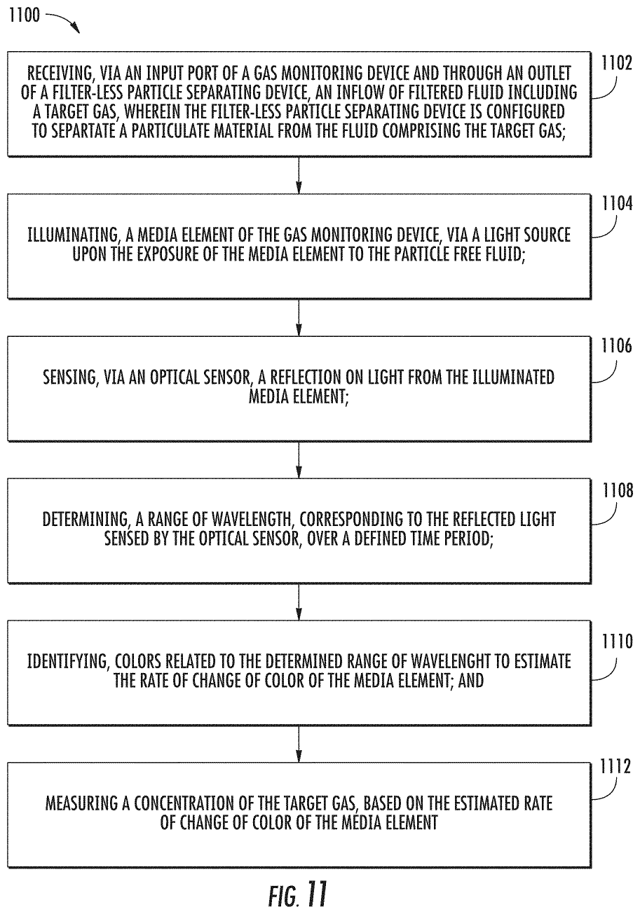

In accordance with said example embodiments, the processing unit 218 may be configured to receive values determined from the wavelength of the reflected light sensed by the optical sensor and measure the concentration of the target gas from the filtered fluid based on the received values. For instance, the processing unit 218 may measure the concentration based on estimating a rate of change of color of the media element identified from processing the determined wavelength of the reflected light. Further details of the measurement of the concentration of the target gas based on the estimation of the rate of change of the color are described in reference to FIGS. 10 and 11.

In accordance with another example embodiment, the sensing unit 220 may include an imaging device, for instance, a RGB camera or a digital camera, that may be configured to capture an image of the media element 220-1. In this regard, in an embodiment the imaging device may capture one or more images the media element 220-1 at instances before and after the media element 220-1 has been exposed to the filtered fluid including the target gas. The processing unit 218, in this aspect, may access the captured images from the imaging device and may further process the captured images and based on image processing may determine a rate of change in the color of the media element 220-1 to measure a concentration of the target gas present in the filtered fluid.

FIG. 3 is a schematic representation depicting a filter-less particle separation unit FLPS (300) for a fluid monitoring system. FIG. 3 particularly depicts a perspective view of an external structure 310 of the FLPS 300 and a diagram representing an internal structure 350 of a particle separation unit of the FLPS 300. Referring to the perspective view representing the external structure 310, the FLPS 300 includes an adapter unit 312, a particle separation unit 314, a particle collector 316, and a flowmeter unit 318.

The adapter unit 312 extends out from an end including an opening 313 towards the particle separation unit 314 of the FLPS 300. In this regard and according to some example embodiments, the adapter unit 312 may be mechanically engaged via means, for instance snap fit elements or threadings, for facilitating engagement of the adapter unit 312 to an inlet (not shown) of the particle separation unit 314. In accordance with an example embodiment, an outlet 320 of the particle separation unit 314 extends out to connect to a conduit unit 322 include one or more ports, which is further connected to the particle collector 316. The particle collector 316, is further connected, via a piping element 324 to the port 318-2 of the flowmeter unit 318. The FLPS 300 further includes an outlet 326 (similar to the outlets 108-1 and 208-2 as described in FIGS. 1 and 2 respectively). The flowmeter unit 318 further includes, a needle valve 318-2, and two ports 318-2 and 318-3.

In accordance with some example embodiments described herein, the adapter unit 312 may be operable to allow inflow of a fluid via the opening 313. In this aspect, the fluid may flow upward through the opening 313 having an aperture with a diameter. In some examples the diameter is within a range from about 10 mm to about 15 mm or more preferably within a range from about 8 mm to about 12 mm, or even more preferably from about 7 mm to about 10 mm, respectively.

The adapter unit 312, as illustrated herein, is operable to facilitate a pre-filtering of a fluid that is inflowed into the particle separation unit 314. In accordance with various example embodiments described herein, the pre-filtering herein represents filtering or separation of coarsely sized particulate material present in fluid which may be of a size within a range from about 80 micrometers to about 110 micrometers, or more preferably within a range from about 90 micrometers to about 100 micrometers. In one example embodiment, the pre-filtering herein represents filtering or separation of coarsely sized particulate material present in fluid which may be of a size greater than 100 micrometers. In this regard, the diameter of the aperture of the opening 313 may be defined based on one or more factors, for example depending on average size of particulate materials present in an operational environment in which the fluid monitoring system of the FLPS 300 is to be installed.

In some example embodiments, the aperture of the opening 313 is of the diameter relatively larger than an aperture of the inlet of the particle separation unit 314. The larger diameter of the aperture of the opening 313 facilitates the fluid to flow upward in a volumetric flow rate which is relatively lower than a volumetric flow rate at which the fluid flows in a downward direction towards the inlet of the particle separation unit 314, thereby causing separation of coarsely sized particles from the fluid due to inertial effect.

Referring to the view depicting an internal structure 350 of the particle separation unit 314, according to an example embodiment, the particle separation unit 314 includes an inlet 351 having a first end 352 and a second end 353. The first end 352 and the second end 353 defines an annular flow passage 356 that is operable to facilitate an inflow of the fluid from the inlet 351 and further eject the fluid out at a defined volumetric flow rate. In this regard, the annular flow passage 356 towards the second end 353 defines an acceleration nozzle 355.

The acceleration nozzle 355, in accordance with said example embodiments, is operable to accelerate the inflow of the fluid that inflows through the inlet 351, passes through the annular flow passage 356, and ejects out from an aperture of the acceleration nozzle 355.

In one example embodiment, the acceleration nozzle 355 is operable to accelerate the inflow of the fluid through the annular flow passage 356 at velocity within a range from about 10 m/sec to about 20 m/sec, more preferably within a range from about 11 m/sec to about 13 m/sec. In another example embodiment, the acceleration nozzle is operable to accelerate the inflow of the fluid through the annular flow passage 356 at a velocity of about 12.46 m/sec. In this aspect, the inlet 351 comprises an aperture A1 of diameter D1 and the acceleration nozzle 355 comprises an aperture A2 of diameter D2, such that the diameter D2 of the acceleration nozzle 355 is relatively smaller than the diameter D1 of the inlet 351. In this regard and in accordance with some example embodiments described herein, the diameter D1 of the inlet 351 is within a range from about 5 mm to about 10 mm, or more preferably within a range from about 4 mm to about 7 mm, or even more preferably from about 3 mm to about 5 mm and the diameter D2 of the acceleration nozzle 355 is within a range from about 0.6 mm to about 1.5 mm, or more preferably within a range from about 0.8 mm to about 1.5 mm, or even more preferably from about 0.7 mm to 1.2 mm. In one example embodiment, the diameter D2 of the acceleration nozzle 355 is 1.2 mm. Further, the particle separation unit 314 of the FLPS 300 comprises a particle separation zone 357 that is operable to receive the fluid that ejects out from the acceleration nozzle 355.

In accordance with some embodiments described herein, the particle separation zone 357 extends outwardly from the acceleration nozzle 355 and defines at least one cavity 358. The at least one cavity 358, in accordance with said embodiments, is of a doughnut shape form factor that extends out from the acceleration nozzle 355 and protrudes further at two ends 359 and 360 respectively of the particle separation zone 357. Further details related to the geometry and form factor of the at least one cavity 358 are described in reference to FIG. 4.

According to said example embodiments, the particle separation unit 314, of the FLPS 300, is operable to separate out particulate material present in the fluid that may inflow through the inlet 351. To this extent, the acceleration nozzle 355 of the particle separation unit 314 ejects the fluid at a defined volumetric rate (i.e. volume velocity or rate of fluid flow or volume of fluid flowing per minute) required for separating out the particulate material and generating a self-cleaning stream pattern of the fluid as the fluid flows into the at least one cavity 358 of the particle separation zone 357. For instance, and according to one example embodiment, the acceleration nozzle 355 may be operable to eject the fluid into the at least one cavity 358 at a velocity within a range 11 m/sec to 16 m/sec, more particularly within a range from about 13 m/secs to about 15 m/secs. The at least one cavity 358 of the particle separation unit 314, due to its form factor, is operable to generate the self-cleaning stream pattern of fluid flow that prevents any deposition of particulate material on an internal surface of the particle separation unit 314. In this regard, the fluid inflowed into the at least one cavity 358 of the particle separation zone 357 is turbulent and has a volumetric flow rate within a range from about 800 cc/min to about 1100 cc/min. Further, in accordance with said example embodiments, a diameter D3 of a maximum aperture the at least one cavity 359, may be within a range from about 13 mm to about 20 mm, or more preferably within a range from about 15 mm to about 17 mm. Further details related to the flow of the fluid in the at least one cavity 358 of the particle separation unit 314 are described in reference to FIG. 4.

As illustrated, the end 359 of the at least one cavity 358 defining the particle separation zone 357 extends further to define a first outlet 361 and the end 360 extends further to define a second outlet 362 of the FLPS 300. In this regard, the first outlet 361 of the FLPS 300 may correspond to a primary outlet, for instance the outlet 326, that may be operable to facilitate an outflow of filtered fluid and the second outlet 362 may correspond to a secondary outlet that may facilitate collection of particulate material separated out from the inflowed fluid into the particle separation unit 314. In this aspect, the first outlet 361 represented in the view of internal structure 350 of the FLPS 300 may correspond to the outlet 326 represented in the view of the external structure 310 illustrated in FIG. 3. Further, the first outlet 361, in accordance with various embodiments described herein, may be in fluid communication with an input port of a gas detector, for instance, the fluid monitoring chamber 202 as described in FIG. 2. In one example embodiment, the first outlet 361 may be configured to be mechanically engaged with the input port 212 of the fluid monitoring chamber 202. To this extent and in accordance with said example embodiment, a distance corresponding to the mechanical engagement between the first outlet 361 and the input port 212 of the fluid monitoring chamber 202, i.e. the distance the filtered fluid travels before being exposed to the sensing unit 220 of the fluid monitoring chamber 202, may be within a range from about, 28 mm to about 35 mm, or more particularly within a range from about 30 mm to about 33 mm, or even more particularly 32 mm, in accordance with one embodiment of the present invention. Further, in accordance with said example embodiments, the first outlet 361 may outflow filtered fluid into the input port of the gas detector for measurement of concentration of the reactive gas present in the filtered fluid.

FIG. 4 is a diagram representing a perspective view 400 of a filter-less particle separating section of the FLPS 300. FIG. 4 also illustrates a simulation view 450 representing a self-cleaning stream pattern of fluid 452 in a cavity 405 (similar to the at least one cavity 358) of a particle separation zone 404 of the FLPS 400, in accordance with an example embodiment described herein. Illustratively, the FLPS 400 includes an inlet 402, the particle separation zone 404, a primary outlet 406, and a secondary outlet 408.

In some examples, the inlet 402 extends from a first end to a second end along a linear axis AA′ to define an annular flow passage 403. In this regard, as illustrated, an aperture A1 of the inlet 402 at a first end is of a diameter D1 and an aperture A2 towards a second end of the inlet 402 is of a diameter D2. In accordance with one embodiment, the diameter D2 of the aperture A2 may be so defined to facilitate the flow of the fluid in the particle separation zone 404 at a volumetric flow rate within a range from about 700 cc/min to about 1300 cc/min, or more preferably within a range from about 900 cc/min to about 1060 cc/min, and even more preferably from about 810 cc/min to about 860 cc/min.

Further, as illustrated, the particle separation zone 404 extends out from the inlet 402 which further extends out into the primary outlet 406 along an axis BB′ perpendicular to the linear axis AA′. To this extent, the annular flow passage 403, between the first end and the second end, defines an acceleration nozzle 407 with the aperture A2 and the diameter D2. In this aspect, the diameter D2 of the acceleration nozzle 407 is relatively smaller to the diameter D1 of the aperture A1, and may depend on a desired ‘volumetric rate’ at which a fluid is to be inflowed into the particle separation zone 404 of the FLPS 400. In this aspect, the volumetric rate at which the acceleration nozzle 407 ejects out the fluid into the particle separation zone 404 effects a separation of particulate material present, particularly based on a size of the particulate material, present in the fluid.

In some example embodiments, the acceleration nozzle 407 is operable to, firstly, accelerate the inflow of the fluid as the fluid passes through the annular flow passage 403 and secondly, eject the fluid into the particle separation zone 404 at a defined volumetric flow rate. According to example embodiments, the acceleration nozzle 407 is operable to eject the fluid at a velocity within a range from about 12 m/sec to about 16 m/sec, more particularly within a range from about 13 m/secs to about 15 m/secs. In this regard and in one example embodiment, the acceleration nozzle 407 is operable to eject the fluid at the volumetric flow rate with a range from about 700 cc/min to about 1300 cc/min, more preferably within a range from about 800 cc/min to about 1100 cc/min.

In accordance with various embodiments described herein, the particle separation zone 404 extends out from the acceleration nozzle 407 thereby defining a cavity 405 in which the fluid flows upon being ejected out from the acceleration nozzle 407. In this regard, the cavity 405 is of a doughnut shaped form factor. Further, the cavity 405 of the FLPS 400 is operable to generate a self-cleaning stream pattern of the fluid and to separate particulate material from the fluid based on at least, an inertia and size of the particulate material present in the fluid.

Referring to the simulation view 450 of the FLPS 400 and as the fluid inflows 451 via the annular flow passage 403 and further enters the particle separation zone 404, a self-cleaning stream pattern 452 of the fluid is formed. In this regard, referring to the self-cleaning stream pattern 452 of the fluid, the turbulent flow follows a circular path such that the fluid flows in two forms 405a and 405b of the fluid within the cavity 405. To this extent, the self-cleaning stream pattern 452 facilitates flow of the fluid inside the cavity 405 in such a manner that prevents any deposition of particulate material present in the fluid on an internal surface 455 of the cavity 405.

In one example embodiment, a volumetric flow rate of the fluid in the self-cleaning pattern stream 452 within the cavity is within in a range from about 360 cc/min to about 550 cc/min, or more preferably from about 410 cc/min to about 510 cc/min. As the self-cleaning pattern stream 452 facilitates fluid flow within the cavity 405 the particulate material is separated from the fluid and gets outflowed 454 in a direction 412 into the secondary outlet 408, thereby increasing an overall life-cycle of the particle separation unit 404. In this regard and in one embodiment, the particulate material separated from the fluid may be outflowed along with a by-pass flow within a volumetric range from about 250 cc/min to about 740 cc/min, or more preferably from about 290 cc/min to about 690 cc/min. Accordingly, filtered fluid 453, inflows in a direction 410 into the primary outlet 406 of the FLPS 400. In this aspect, the FLPS 400 includes a collection probe (not shown) connected to the secondary outlet 408 which collects the particulate material outflowed 454 via the secondary outlet 408. In this aspect and in one example embodiment, the particle separation unit 404 may be configured to separate out any particulate material of a size within a range from about 1.5 micrometers to about 4 micrometers, or more preferably within a range from about 2 micrometers to about 3 micrometers, or even more preferably from about 2.4 micrometers to about 2.7 micrometers. In another example embodiment, the particle separation unit 404 may be configured to separate out any particulate material of a size greater than 2.5 micrometers present in the fluid.

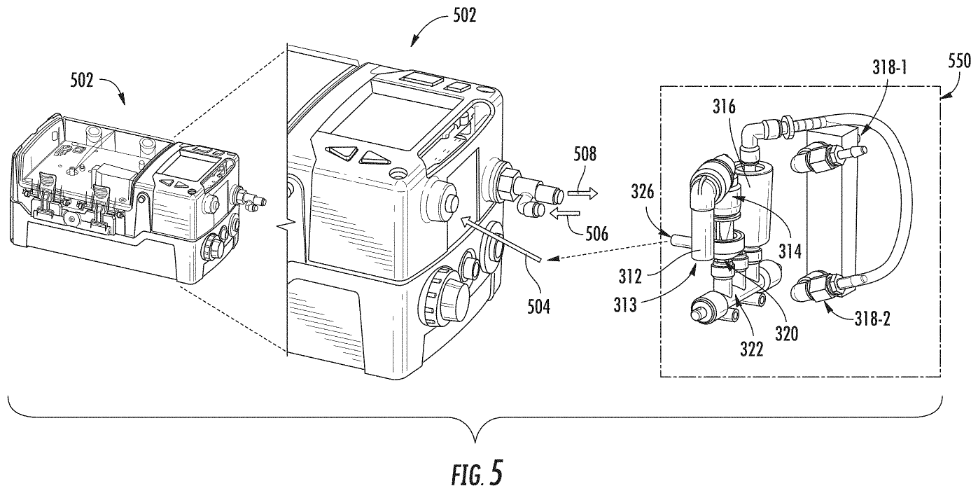

FLPS 400, in accordance with various embodiments described herein, the primary outlet 406 of the particle separation unit 404 is operable to facilitate an inflow of the filtered fluid 453 into a chamber of the gas detector for measuring concentration a target gas present in the filtered fluid 453. In one embodiment, the filtered fluid may outflow from the primary outlet 406 of the particle separation unit at a volumetric flow rate within a range from about 200 cc/min to about 600 cc/min, or more preferably within a range from about 350 cc/min to about 550 cc/min, or even more preferably within a range from about 410 cc/min to about 510 cc/min. In this regard and in one example embodiment, the primary outlet 406 of the particle separation unit is configured to be in fluid communication with an input port, for example the input port 212 as described in FIG. 2 of a gas detector system. In another example embodiment, the primary outlet 406 of the particle separation unit is configured to be mechanically engaged with an input port, for example the input port 212 as described in FIG. 2 of a gas detector system. Further details of assembling of outlets of the particle separation unit with input and output ports of a gas detector system as described in reference to FIG. 5

FIG. 5 is a perspective view of a fluid monitoring system 500 that illustrates an assembly of a fluid monitoring chamber 502 in fluid communication with a virtual impaction based filter-less particle separation unit (VI-FLPS) 550. In accordance with various embodiments described herein, the fluid monitoring chamber 502 may correspond to a gas detector such as, but not limited to, a tape based gas detector, catalytic bead gas sensors, electrochemical gas sensors, infrared based gas detectors, photo-ionization based gas detectors, and/or the like. According to various embodiments described herein, the VI-FLPS 550 may correspond to any of the FLPS 100, 204, or 300, or 400 as described with reference to FIGS. 1-4. In this regard, the VI-FLPS 550 may be configured to separate out any particulate material present in the fluid based on virtual impaction.

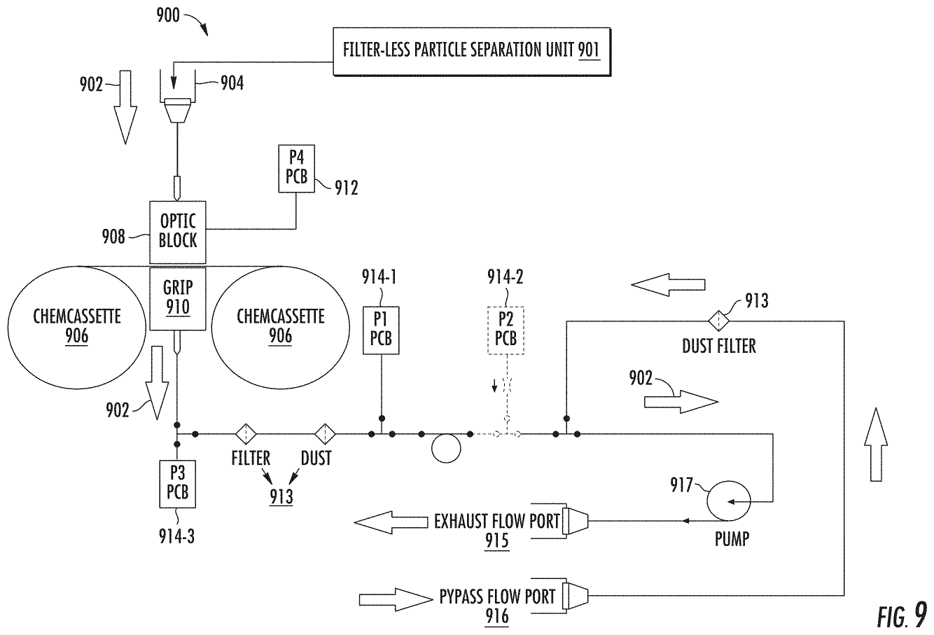

The fluid monitoring chamber 502 includes an input port 504 to facilitate an inflow of fluid that is filtered out by the VI-FLPS 550. In this aspect, the input port 504, may be configured to mechanically engage with an outlet of the VI-FLPS 550. Herein, the outlet may correspond to the outlet 326 of the FLPS 300 or the primary outlet 406 of the particle separation unit 400, as described in FIGS. 3 and 4 respectively. In this regard, upon assembling the fluid monitoring chamber 502 with the VI-FLPS 550 and in operation, a sample gaseous mixture including a target gas enters the VI-FLPS 550, via the adapter inlet 312, and flows out from the outlet 326 of the VI-FLPS 550 as the filtered fluid. The filtered fluid from the outlet 326 further inflows into the fluid monitoring chamber 502 via the input port 504. Further details related to inflow of the filtered fluid in the fluid monitoring chamber 502 and subsequent operations performed by the fluid monitoring chamber 502 for the measurement of the concentration of the target gas present in the filtered fluid are described in FIG. 9.

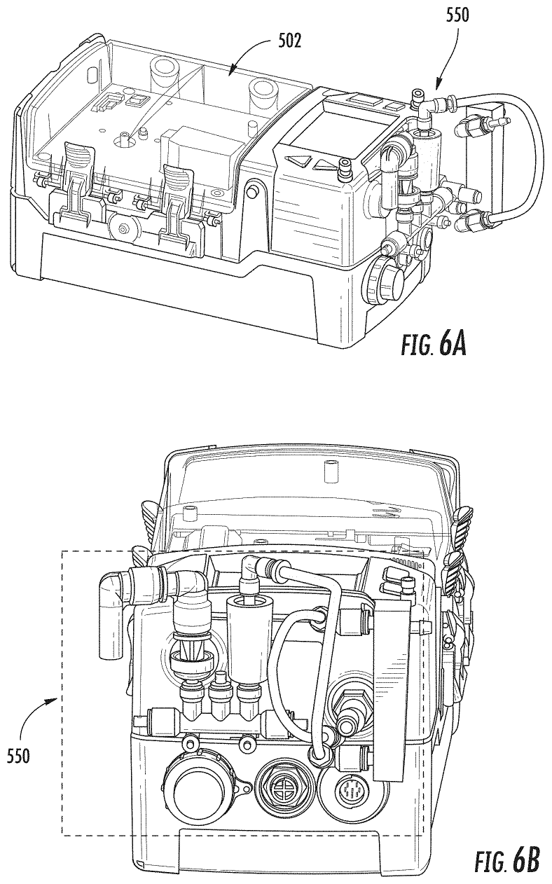

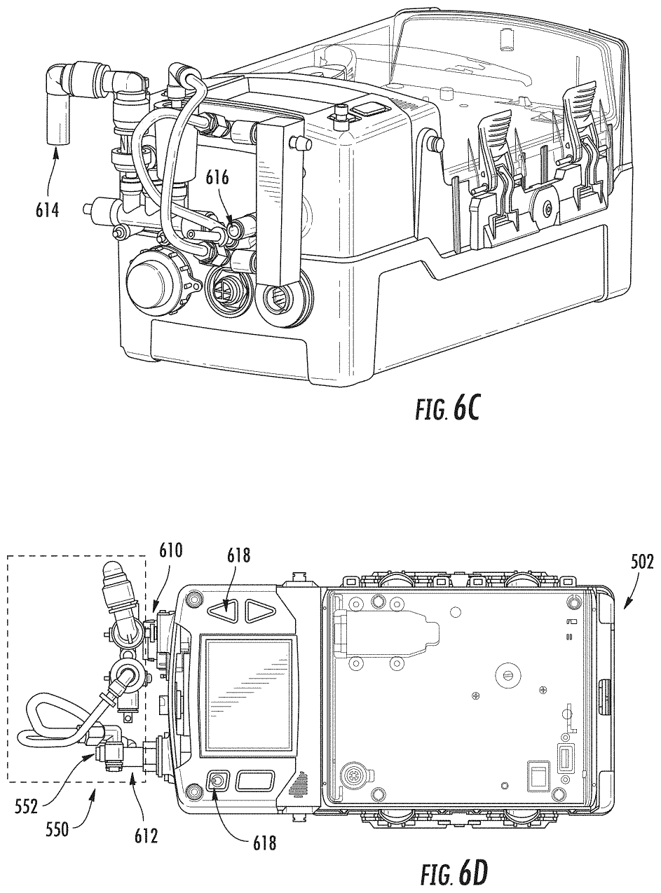

As illustrated, the fluid monitoring chamber 502 also includes a by-pass flow port 506 and an exhaust port 508. In this regard, the by-pass flow port 506 may be configured to be mechanically engaged with a secondary outlet of the VI-FLPS 550, such as the outlet 108-2, the outlet 208-1 of the FLPS 204, the outlet 320, and/or the secondary outlet 408 of the particle separation unit 400. The by-pass flow port 506 herein may be configured to facilitate a by-pass flow required to maintain a flow rate within the VI-FLPS 550. In this aspect, the flow rate may be controlled using the flow-meter unit 318 and the needle valve 318-1 as described in FIG. 3. Further the exhaust port 508 of the fluid monitoring chamber 502 may be operable to outflow an exhaust of air left over after the measurement of a concentration of the gas from the fluid. FIGS. 6A-6D illustrates multiple views of the fluid monitoring system 500 representing the VI-FLPS 550 assembled with the fluid monitoring chamber 502.

FIGS. 6A and 6B illustrate multiple perspective views of the fluid monitoring system 500 where the fluid monitoring chamber 502 is assembled with the VI-FLPS 550. FIG. 6C illustrates a side view of the fluid monitoring system 500 where the fluid monitoring chamber 502 is assembled with the VI-FLPS 550. FIG. 6D illustrates a top view of the fluid monitoring system 500 where the fluid monitoring chamber 502 is assembled with the VI-FLPS 550 unit. Referring to multiple views represented in FIGS. 6A-6D, the fluid monitoring chamber 502 may correspond to a gas detector, for example the fluid monitoring chamber 202 as described in FIG.2 and the VI-FLPS 550 unit corresponds to the FLPS (e.g., 100, 204, 300) as described in FIG. 3.

FIG. 6D, which is the top view of the fluid monitoring system 500, illustrates a mechanical engagement 610 of the outlet 326 of the VI-FLPS 550 having the input port 504 of the fluid monitoring chamber 502. The mechanical engagement herein may be performed using means that include, but are not limited to, a threading arrangement or a snap-fit arrangement, and/or the like. In some embodiments, each of the outlet 326 and the input port 504 of the fluid monitoring chamber 502 may be mechanically engaged using standard push-to-connect fittings (for example, polyvinyl chloride (PVC)) without any additional components.

Further, mechanical engagement 612 of an outlet 552 of the VI-FLPS 550 with the by-pass port 506 of the fluid monitoring chamber 502 is illustrated. In this regard, the outlet 552 is an outlet of the flow-meter unit 318 described in represented in FIG. 3. To this extent, referring to FIG. 6C, in an operation of the fluid monitoring system 500, the fluid inflows 614 from the adapter inlet of the VI-FLPS 550 is filtered and flows in filtered form into the fluid monitoring chamber 502. Upon the measurement of the concentration of the target gas by the fluid monitoring chamber 502, the gas is exhausted out 616 from the exhaust port of the fluid monitoring chamber 502.

In accordance with various embodiments described herein, the fluid monitoring chamber 502 may additionally include various components of a gas detector system. For instance, as illustrated from the top view represented in FIG. 6D, the fluid monitoring chamber 502 includes one or more actuator buttons 618 for performing various operations of the fluid monitoring chamber 502. Additionally, the fluid monitoring chamber 502 may include one or more peripherals interfaces, that may also communicate with an input/output (I/O) sub-system. The I/O sub-system herein may include a touch sensitive display unit and a processing circuitry to process touch based inputs provided on the touch sensitive display.

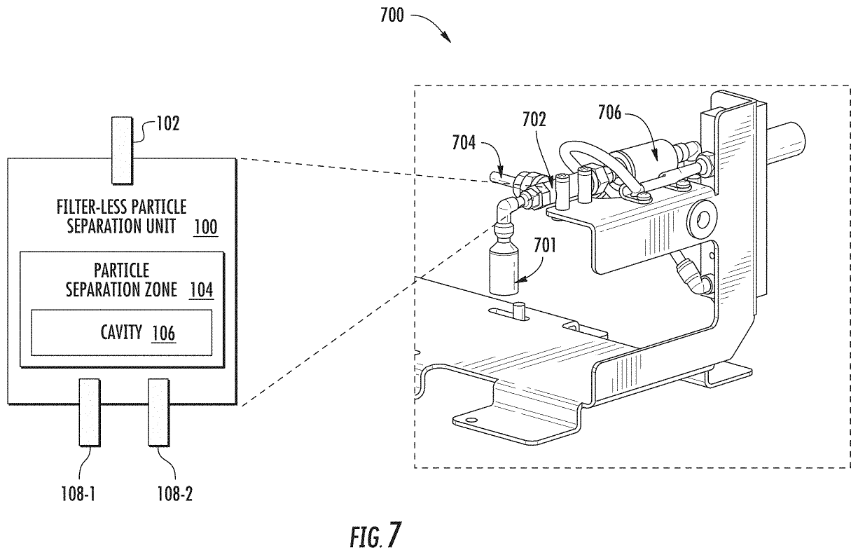

FIG. 7 schematically illustrates a diagram representing a vacuum venturi ejector based filter-less particle separation unit (VV-FLPS) 700 for a fluid monitoring device, in accordance with an example embodiment described herein. According to an example embodiment, the VV-FLPS 700 may correspond to, but is not limited to, any of the FLPS 100, 204, or 300 or 400 as described in reference to FIGS. 1-4. In this regard, the VV-FLPS 700 may be configured to separate out any particulate material present in the fluid, based on vacuum venturi ejection, and provide filtered fluid to a gas detector system. In this aspect, a vacuum venturi ejector pump may be modified by adding a filter-less particle separation unit 702 that operates based on virtual impaction, similar to the particle separation unit 314, 404, 450, as described in FIGS. 3 and 4 respectively, while still relying on components of the vacuum venturi ejector pump that provides virtual impaction effect for inflowing the fluid and outflowing the filtered fluid.

The filter-less particle separation unit 702, in this aspect, may be configured to separate out particulate material present in the fluid that is to be inflowed into the VV-FLPS 700. To this extent, the fluid or a sample of gas including multiple target gases may be inflowed, via an adapter unit 701 to a vacuum ejector pump of the VV-FLPS 700, using gas port 212 and bypass port 224 of monitoring chamber 202 as described in reference to FIG. 2. In this aspect, the fluid inflows into the filter-less particle separation unit 702 in compressed form. According to said embodiment, the filter-less particle separation unit 702 includes one or more cavities (similar to, but not limited to, the cavity 106 or 210-1 or 405 as described in reference to FIGS. 1, 2, and 4) that receive the inflow of the fluid at a defined volumetric flow rate. The cavity of the filter-less particle separation unit 702 due to its unique form factor, facilitates separation of the particulate material, like dust particles from the fluid based on its size and inertia, in a similar manner, as described in reference to FIG. 4.

As illustrated, the VV-FLPS 700 also includes a collection probe 706, which collects the particulate material separated out from the fluid by the filter-less particle separation unit 702 of the VV-FLPS 700. Illustratively, the VV-FLPS 700 also includes an outlet 704 that facilitates outflow of the filtered fluid to a gas detector system. In this regard, the outlet 704 may be configured to be in fluid communication and/or mechanically engaged with an input port (for example, the input port 504 of the fluid monitoring system 500) of the gas detector.

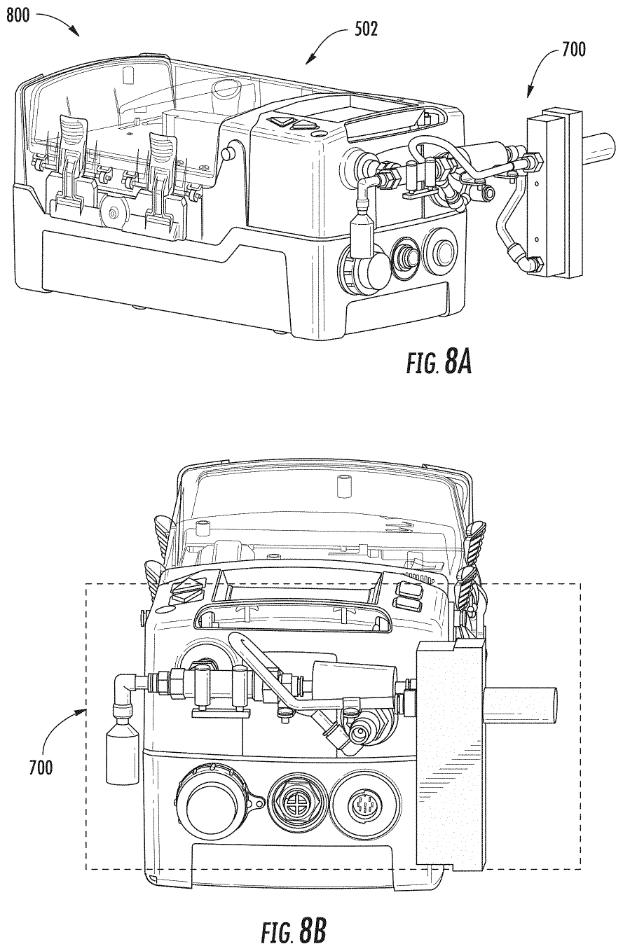

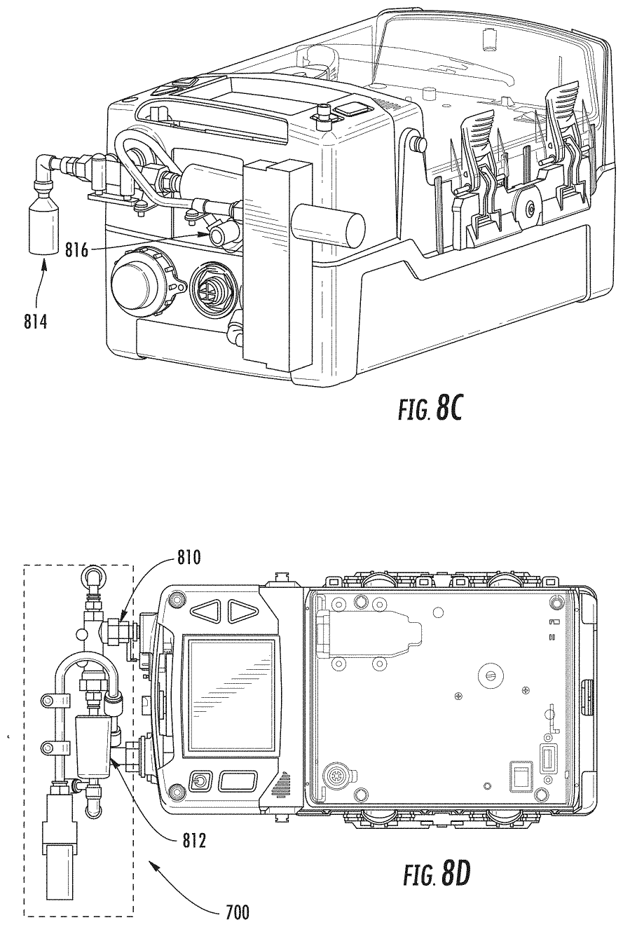

FIGS. 8A-8D illustrate multiple views of an example implementation of fluid monitoring system where the VV-FLPS 700 is assembled to a fluid monitoring chamber, for instance the fluid monitoring chamber 502. FIG. 8C illustrates a side view of the fluid monitoring system 800 where the fluid monitoring chamber 502 is assembled with the VV-FLPS 700 unit. FIG. 8D illustrates a top view of the fluid monitoring system 800 where the fluid monitoring chamber 502 is assembled with the VV-FLPS 700 unit. Referring to multiple views represented in FIGS. 8A-8D, VV-FLPS 700 unit may correspond to, but not limited to, the FLPS (e.g., 100, 204, 300, 400) as described in FIGS. 1-4.

Referring to FIG. 8D, the top view of the fluid monitoring system 800 illustrates a mechanical engagement 810 of the outlet 704 of the VV-FLPS 700 with the input port 504 of the fluid monitoring chamber 502. Further, another mechanical engagement 812 of an outlet of the VV-FLPS 700 with the by-pass port 506 of the fluid monitoring chamber 502 is illustrated. Referring to FIG. 8C, in an operation of the fluid monitoring system 800, the fluid inflows 814 from the adapter inlet 701 of the VV-FLPS 700, gets filtered out and flows in filtered form into the fluid monitoring chamber 502. Further, upon the measurement of the concentration of the target gas by the fluid monitoring chamber 502, the fluid is exhausted out 816 from the exhaust port of the fluid monitoring chamber.

FIG. 9 illustrates a flow diagram depicting a flow of filtered fluid in a gas monitoring system 900, for measuring a concentration of a target gas present in the filtered fluid, in accordance with an example embodiment described herein. The blocks of the flowchart support combinations of means for performing the specified functions and combinations of operations for performing the specified functions. It will also be understood that one or more blocks of the flowchart, and combinations of blocks in the flowchart, can be implemented by the embodiments described herein. The gas monitoring system 900 illustrated herein may correspond to any of the fluid monitoring chamber 202, 502 as described in FIGS. 2 and 5 respectively. As illustrated, a gas sample including one or more target gases, may inflow 902 via an inlet 904 of the gas monitoring system 900. In this regard, the inlet 904 may correspond to the input port 212 or 504 as described in FIGS. 2 and 5 respectively. In accordance with an embodiment, the filtered fluid may be inflowed into the inlet 904, via an outlet of a filter-less particle separation unit 901, for instance, but not limited to, the FLPS 100, 204, 300, 400 as described in FIGS. 1-4.

As the filtered fluid inflows into a gas monitoring chamber (similar to, but not limited to, the fluid monitoring chamber 202, 502 as described in FIGS. 2 and 5) of the gas monitoring system 900, a media element, for instance, a chemcassette tape gets exposed to the filtered fluid. In this regard, the chemcassette tape 906 operates like a ‘color changing indicator’ that changes its color upon being exposed to a target gas present in the filtered fluid. In this aspect, the color of the chemcassette tape changes because of a chemical reaction between a coating of the chemcassette tape and the target gas present in the filtered fluid. To this extent, according to various embodiments described herein, the chemcassette tape 906 of the gas monitoring system 900 may be selected based on a type of the target gas to be detected or monitored by the gas monitoring system 900. Illustratively, the gas monitoring system 900 includes an optics block 908 and a gripping element 910. In this regard, the chemcassette tape 906 is supported by the gripping element and positioned so that a surface of the chemcassette tape 906 is exposed to the optics block 908. The optics block 908, includes an optical source and an optical sensor. As illustrated, the optics block 908, in one example embodiment may be communicatively coupled to a control unit on a printed circuit board (PCB) 912 that may control the operations performed by the optics block 908. In this aspect, the optics block 908 may be configured to sense a change in the color of the chemcassette tape 906, in an instance, when the chemcassette tape 906 is being exposed to the inflowed filtered fluid 902. Further details of related to detection of the change in color in the media element, i.e. the chemcassette tape 906 and using it for the measurement of the concentration of the target gas are described in FIGS. 10 and 11.

The filtered fluid 902, thereafter according to some embodiments, may flow into one or more additional filters 913, such as membrane based dust filters and further out from the gas monitoring system 900 via the exhaust port 915. Further, as illustrated, the gas monitoring system may include one or more printed circuit boards (PCBs) 912-1 and 914-2 that may be configured to monitor a pressure different across one or more sections of the gas monitoring system 900. Illustratively, the gas monitoring system 900 includes a by-pass port 916 that may be connected with an outlet of the filter-less particle separation unit 901 (such as the outlet 208-1 as described in FIG. 2) to facilitate flow of by-pass upon separating the particulate material from the fluid by the filter-less particle separation unit 901. In this aspect and in one embodiment, the by-pass flow may be controlled using a flow meter unit including a needle valve of the filter-less particle separation unit 901 and/or using a pump 917. In accordance with various example embodiments described herein, the fluid monitoring system (e.g., 200, 500, 900) may use various techniques and may additionally or alternatively include various components related to measuring concentration of one or more target gases as described in U.S. patent application Ser. No. 11/923,325, filed Oct. 24, 2007, entitled, “GAS ANALYZER CASSETTE SYSTEM” and U.S. patent application Ser. No. 11/762,891 filed Jun. 14, 2007, entitled, “GAS ANALYZER APPARATUS AND METHOD OF ANALYZING GASES” the entire contents of which are incorporated by reference herein.

FIGS. 10 and 11 illustrates example flowcharts of operations performed by the fluid monitoring system including a filter-less particle separation unit, for instance the FLPS (e.g., 100, 204, 300, 400, 550, and 700 described in FIGS. 1-7 respectively) in accordance with example embodiments of the present invention. The blocks of the flowchart support combinations of means for performing the specified functions and combinations of operations for performing the specified functions. It will also be understood that one or more blocks of the flowchart, and combinations of blocks in the flowchart, can be implemented by the embodiments described herein.

FIG. 10 illustrates flowchart describing a method 1000 of measuring concentration of a target gas in a fluid, filtered using a filter-less particle separation unit. At step 1002, a fluid monitoring system (e.g., 200, 500, 900) includes means, such as an input port (e.g., 212, 504, 904) of a fluid monitoring chamber (e.g., 202, 502) and through an outlet (e.g., 108-1, 208-2, 326, 361, 406, 704) of the FLPS (e.g., 100, 204, 300, 400, 550, and 700) to receive an inflow of filtered fluid including a target gas. In this aspect, the FLPS (e.g., 100, 204, 300, 400, 550, and 700) of the fluid monitoring system (e.g., 200, 500, 900) includes means, such as a particle separation zone (104, 210, 357, 404) including a cavity (106, 210-1, 358, 405) that may be configured to (a) generate a self-cleaning stream pattern of the fluid to separate particulate material from the fluid based on at least an inertia and size of the particulate material present in the fluid and (b) facilitate the inflow of the filtered fluid into the input port (e.g., 212, 504, 904) of the fluid monitoring chamber (e.g., 202, 502). In this regard, the FLPS (e.g., 100, 204, 300, 400, 550, and 700) of the fluid monitoring system (e.g., 200, 500, 900) is be configured to receive an inflow of the fluid and separate out any particulate material from the fluid. Further, the FLPS (e.g., 100, 204, 300, 400, 550, and 700) of the fluid monitoring system (e.g., 200, 500, 900) may provide the filtered fluid, via its outlet (e.g., 108-1, 208-2, 326, 361, 406, 704) into the input port (e.g., 212, 504, 904) of the fluid monitoring chamber (e.g., 202, 502). In this aspect and in accordance with various embodiments described herein, at least one of the outlet (e.g., 108-1, 208-2, 326, 361, 406, 704) of the FLPS (e.g., 100, 204, 300, 400, 550, and 700) and the input port (e.g., 212, 504, 904) of the fluid monitoring chamber (e.g., 202, 502) may be configured to be in fluid communication and/or mechanically engaged to each other, in a manner, so as to facilitate transport of the filtered fluid at an optimum performance without an impact on performance of the FLPS (e.g., 100, 204, 300, 400, 550, and 700) to separate the particulate material. To this extent, in one example embodiment, a distance corresponding to the mechanical engagement between the outlet (e.g., 108-1, 208-2, 326, 361, 406, 704) of the FLPS (e.g., 100, 204, 300, 400, 550, and 700) and the input port (e.g., 212, 504, 904) of the fluid monitoring chamber (e.g., 202, 502), i.e. the distance the filtered fluid travels before being exposed to the sensing unit 220 of the fluid monitoring chamber (e.g., 202, 502) may be within a range from about 28 mm to about 35 mm, or more preferably within a range from about 30 mm to about 33 mm, or even more particularly at 32 mm in accordance with one embodiment of the present invention.

At step 1004, the fluid monitoring system (e.g., 200, 500, 900), includes means, such as the processing unit 218 to determine a rate of change of color of a media element, for instance the media element 220-1 of the fluid monitoring chamber. The change of the color of the media element 220-1, in this aspect, occurs upon exposure of the media element 220-1 to the filtered fluid that is received via the input port (e.g., 212, 504, 904). In this regard, in accordance with some embodiments, an optical block chamber of the fluid monitoring chamber (e.g., 202, 502) may receive the inflow of the filtered fluid that is outflowed from the FLPS (e.g., 100, 204, 300, 400, 550, AND 700) into the fluid monitoring chamber (e.g., 202, 502). Further, as the filtered fluid inflows into the optical block chamber, the media element 220-1 positioned within the chamber may be get exposed to the filtered fluid. In this aspect, the color of a surface of the media element 220-1 may start to change due to a chemical reaction between a target or reactive gas present in the filtered fluid. As the filtered fluid inflows into the input port (e.g., 212, 504, 904) of the fluid monitoring chamber, the sensing unit 220 may detect the change in the color of the media element 220-1. In this regard, data from the sensing unit 220, i.e. sensed values indicative of the change of the color sensed by the sensing 220 may be accessed by the processing unit 218 to determine the rate at which the color of the media element 220-1 changes. Further details related to determination of the rate of the change of the color of the media element 220-1 based on the sensing unit 220 are described in reference to FIG. 11

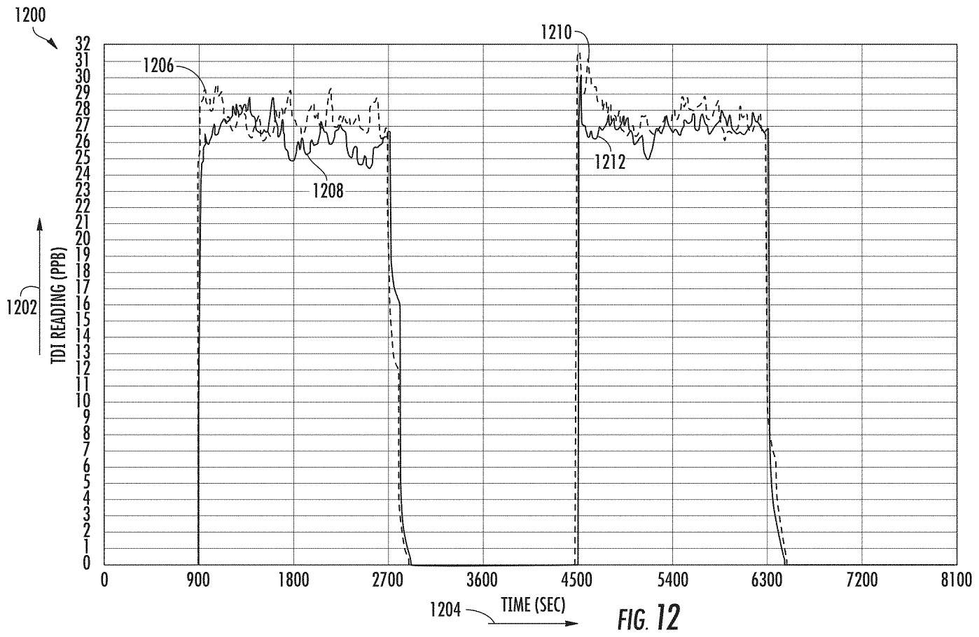

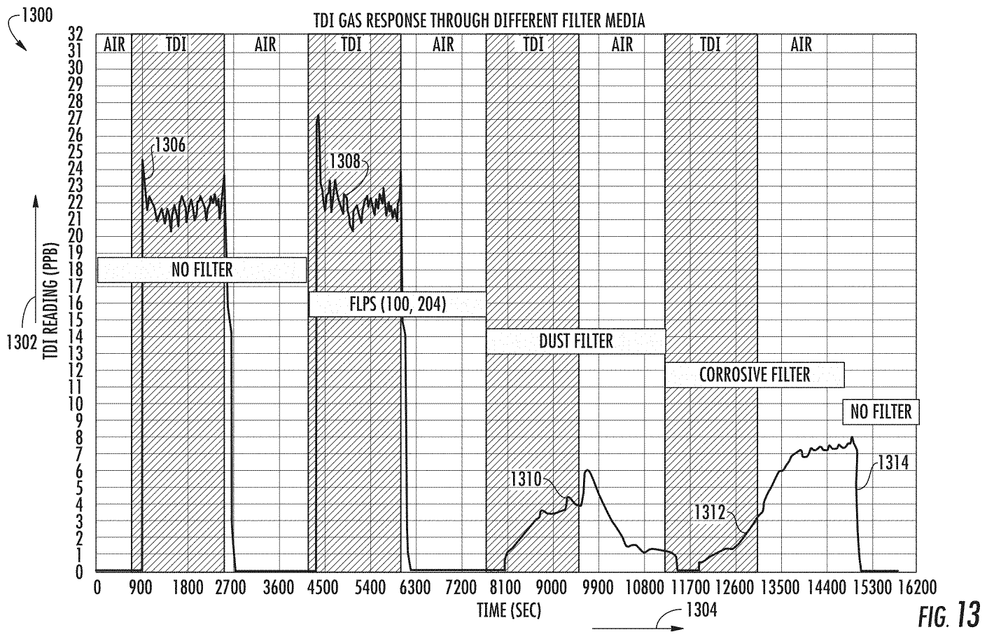

At step 1006, the fluid monitoring system (e.g., 200, 500, 900), includes means, such as the processing unit 218 to measure a concentration of a target gas present in the fluid. In this regard, the processing unit 218 may measure the concentration of the target gas based on the determined rate of change of the color of the media element 220-1. In this aspect, the concentration of the target gas present in the fluid may be measured by the fluid monitoring system (e.g., 200, 500, 900) in ‘parts per billion’ (ppb). Further details related to sample values of concentration of various reactive gases measured by the fluid monitoring system (e.g., 200, 500, 900) upon filtering of the fluid by the FLPS (e.g., 100, 204, 300, 400, 550, an 700) are described in reference to FIGS. 12 and 13.

FIG. 11 illustrates a flowchart describing a method of monitoring concentration of target gas based on determining a rate of change in color of a media element, in accordance with some example embodiments described herein.

At step 1102, a gas detector, for example the fluid monitoring chamber 202 of the fluid monitoring system (e.g., 200, 500, 900) may include includes means, such as the input port (e.g., 212, 504, 904) to receive an inflow of filtered fluid including a reactive gas. The filtered fluid, herein, may correspond to a ‘filtered form’ of a mixture of gases present in a sample of air in an operating environment where the gas detector may be installed. To this extent, in accordance with various embodiments described herein, the input port (e.g., 212, 504, 904) may receive the inflow of the filtered fluid from a particle separator, such as the FLPS (e.g., 100, 204, 300, 400, 550, and 700). In an operation, according to said embodiments, before inflowing the sample air into the gas detector, the sample air may be first filtered out by the FLPS (e.g., 100, 204, 300, 400, 550, and 700) to remove out any particulate material from the sample air and outflow the mixture of gases in filtered form into the gas detector. As an example, in one embodiment, the filtered fluid may include reactive gases like, di-isocyanate or hydrazine, that are usually hazardous in nature. In such cases, it may be desired to accurately measure a concentration of these gases and subsequently trigger an alarm, as soon as the concentration of such reactive gases is above a defined threshold. To this extent, in order to prevent any contamination of an internal circuitry or internal components, for instance, the sensing unit 220 and the media element 220-1 of the gas detector it may be desired that the fluid inflowed into the gas detector is to be devoid of any particulate material or dust particles. The FLPS (e.g., 100, 204, 300, 400, 550, and 700), as illustrated and described according to various embodiments herein, is configured to separate out such dust particles. To this extent, in accordance with various embodiments described herein, as the FLPS (e.g., 100, 204, 300, 400, 550, and 700) is devoid of any filtering membrane and operates based on any of virtual impaction or venturi vacuum ejection, the FLPS (e.g., 100, 204, 300, 400, 550, and 700) separates out the particles from the sample air, without any loss of the reactive gases by maintaining an unchanged concentration of the reactive gas that inflows into the gas detector. In this regard, the filtered fluid that is received at the input port (e.g., 212, 504, 904) may be inflowed at a volumetric flow rate optimum for accurate measurement of the reactive gas concentration, for instance within a range from about 360 cc/min to about 550 cc/min, more preferably within a range from about 410 cc/min to about 510 cc/min.

At step 1104, the fluid monitoring system (e.g., 200, 500, 900) may include includes means, such as an optical unit including an optical source to illuminate, a media element of the gas detector, for instance the media element 220-1 of the fluid monitoring chamber (e.g., 202, 502). In this aspect and in one embodiment, the sensing unit 220 may include an optical source, for example, one or more light emitting diodes (LEDs) and an optical sensor. The optical source, in this regard, may be configured to project light rays on the media element 220-1, thereby illuminating the media element 220-1. In this regard, in accordance with various embodiments described herein, the optical source may illuminate the media element 220-1, for example a chemically coated tape, upon exposure of the media element 220-1 to the filtered fluid including the reactive gas that may be inflowed into the optical block chamber of the gas detector. To this extent, the sensing unit 220, as described herein, may be positioned within or outside a housing of the optical block chamber.

At step 1106, the fluid monitoring system (e.g., 200, 500, 900) may include includes means, such as the sensing unit 220 including an optical sensor unit that may be operable to sense a reflection and/or transmission of the light from the media element 220-1. In this regard, the optical sensor unit may sense the reflection and/or transmission of the light, in an instance, when the media element 220-1 is illuminated by the optical source and is being exposed to the inflowed filtered fluid including the reactive gas. In accordance with some embodiments, the optical sensor unit may include one or more narrow band light sensors, where each sensor is operable to detect light at different wavelengths. Further, the optical source may correspond to a wide band light source. The one or more optical sensors may be housed in an array and may be operable to detect light at different ranges of wavelengths. In this regard, a range of wavelength for which an optical sensor of the optical sensor unit is configured to detect may be associated with a type of gas which the gas detector may detect based on a change in the color of the media element 220-1 In some embodiments, each sensor of the optical sensor unit is operable to detect approximately a 10 nanometer (nm) range of wavelengths. For example, a light sensor in the optical sensor unit may be operable to detect light at 565±5 nm, while another light sensor of the optical sensor unit may be operable to detect light at 590±5 nm. In other embodiments, the optical sensor unit may be operable to detect light at a wider range of wavelengths, such as 20 nm, 30 nm, 40 nm, 50 100 nm, etc.

At step 1108, the fluid monitoring system (e.g., 200, 500, 900) may include includes means, such as the processing unit 218 operable to determine, a range of wavelength, corresponding to the reflected light sensed by the optical sensor, over a defined time period. In this regard, the processing unit 218 may access, over a period of time, data pertaining to wavelengths associated with light rays reflected from the media element 220-1 and sensed by the optical sensor.

At step 1110, the fluid monitoring system (e.g., 200, 500, 900) may include includes means, such as the processing unit 218 operable to identify, colors related to the determined range of wavelength to estimate the rate of change of color of the media element 220-1. In this regard, the processing unit 218 may be operable to periodically receive detected reflected wavelength information from the optical sensors of the sensing unit 220. In some embodiments, the reflected light information may be monitored periodically, such as every one second or every two seconds. Further, the processor unit may be operable to relate the detected wavelength to the color for that wavelength range, and determine the type of gas, present in the filtered fluid inflowed into the fluid monitoring chamber (e.g., 202, 502), that reacted with the media element 220-1 based on the color detected by the optical sensors. Here, it may be understood that the media element 220-1 upon exposure to the filtered fluid may change to different colors associated with a different type of reactive gas present in the filtered fluid. In some embodiments, the processing unit 218 may access an association (such as a table from a database or a memory unit) that provides a relation between color and type of a gas. Accordingly, the processing unit 218 may be operable to determine a concentration of a target gas present in the filtered fluid based on a rate of change of the color of the media element 220-1. In some embodiments, determining the concentration of the detected gas based on the rate of change of the color of the color changing indicator may comprise, estimating a change in the darkness of the media element 220-1 over the period of time. Additionally, in some embodiments, estimating the rate of change in the darkness of the media element 220-1 may comprise measuring, by the optical sensor, an intensity of the reflected light rays from the media element 220-1.

FIG. 12 graphically illustrates a comparison 1200 of response measured by a gas detector used with a filter-less particle separating unit vs. the gas detector when used without a filtering unit, in accordance with some example embodiments described herein. Illustratively, in the graphical representation, Y-axis represents response of the gas detector upon detection of a target gas present in the fluid. In this regard, the response herein represents a reading 1202 of a gas detector indicating concentration of a target gas in parts per billion (ppb) measured by the gas detector over a range of time 1204 represented on X-axis. In this regard, reading 1206 represents values indicating concentration of the target gas present in the fluid measured in time-interval 900 seconds to 2700 seconds, as measured by the gas detector when used along with a filter-less particle separation unit, for instance, the FLPS 100 or the FLPS 204 as described in FIGS. 1 and 2 respectively. Further, reading 1208 represents values indicating concentration of the target gas present in the fluid measured in time-interval 900 seconds to 2800 seconds, as measured by the gas detector without using any particle filtering unit. Similarly, reading 1210 represents values indicating concentration of the target gas present in the fluid measured in time-interval 4500 seconds to 6400 seconds, as measured by the gas detector when used along with a filter-less particle separation unit, for instance, the FLPS 100 or the FLPS 204 as described in FIGS. 1 and 2 respectively. Further, reading 1212 represents values indicating concentration of the target gas present in the fluid measured in time-interval 4500 seconds to 6400 seconds, as measured by the gas detector without using any particle filtering unit. Illustratively, values corresponding to the readings 1206 and 1210 are comparable or nearly similar, values corresponding to the readings 1208 and 1212. To this extent, similar readings observed in test results, as illustrated in FIG. 12 indicates that using the FLPS (e.g., 100, 204) along with the gas detector doesn't impact, in some examples, an operational performance of the gas detector, which otherwise can be impacted when existing filter based particle separators are used due to loss of the target gases at filter membranes of the filter based particle separators. Further, using the FLPS (e.g., 100, 204) facilitates, in some examples, an inflow of the filtered fluid thereby preventing contamination and subsequent degradation of various components within the gas detector.

FIG. 13 graphically illustrates sample results 1300 indicating responses measured by a gas detector used along with different types of filtering units, such as the FLPS, in accordance with some example embodiments described herein. Illustratively, in the graphical representation, Y-axis represents response of the gas detector upon detection of a target gas present in the fluid. In this regard, the response herein represents a reading 1302 of a gas detector indicating concentration of a target gas in parts per billion (ppb) measured by the gas detector over a range of time 1304 represented on X-axis. Illustratively, readings 1306 and 1314 represent values indicating concentration of a target gas present in a fluid measured by the gas detector when used without any particle separating device or filter unit. Reading 1308 represent values indicating concentration of a target gas present in a fluid measured by the gas detector when used along with a filter-less particle separation unit, for instance the FLPS 100, 204 as described in FIGS. 1 and 2 respectively. Illustratively, readings 1310 and 1312 represents values indicating concentration of a target gas present in a fluid measured by the gas detector when used along with a dust filter and a corrosive filter respectively. Illustratively, values representing the reading 1308 and values representing the reading 1306 are comparable which clearly indicates that use of FLPS 100, 204 along with the gas detector has no negative impact on an accuracy of measurement of target gas concentration by the gas detector. To this extent, illustratively, as indicated from values representing the readings 1310 and 1312, using conventional dust filters or corrosive filters impacts an accuracy with which the gas detector measures gas concentration, as the response of the gas detector upon detection of the target gas present in the fluid is significantly lowered when compared to the reading 1306. Accordingly, by way of implementation of various embodiments described herein, use of the FLPS 100, 204 as described in FIGS. 1 and 2, along with the gas detectors, in some examples, prevents any contamination of internal components of the gas detectors (sensing unit, optical units etc.) and in other aspect, minimizes any losses of sample fluid inflowed into the gas detectors for gas monitoring that would otherwise occur because of reaction of sticky gases present in the sample fluid with filter elements of conventional particle filters.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

1. A filter-less particle separation unit for a gas monitoring system comprising:
an inlet having a first end and a second end that defines an annular flow passage operable to facilitate an inflow of a fluid, the annular flow passage defines an acceleration nozzle between the first end and the second end that is operable to accelerate the inflow and eject the fluid at a defined volumetric flow rate;
a particle separation zone, extending outwardly from the acceleration nozzle, wherein the particle separation zone comprises at least one cavity having a defined form factor and operable to separate particulate material from the fluid; and
an outlet, extending outwardly from one end of the particle separation zone, the outlet operable to facilitate an outflow of filtered fluid to an input port of the gas monitoring system that measures a concentration of a reactive gas present in the fluid.

2. The filter-less particle separation unit of claim 1, wherein the at least one cavity of the particle separation zone is operable to generate a self-cleaning stream pattern of the fluid to separate the particulate material present in the fluid based on at least, an inertia and size of the particulate material.

3. The filter-less particle separation unit of claim 1 further comprising: a collection probe operable to collect the particulate material separated from the fluid in the particle separation zone.

4. The filter-less particle separation unit of claim 1, wherein the particle separation zone separates the particulate material from the fluid based on virtual impaction using one of a virtual impactor or a vacuum venturi ejector.

5. The filter-less particle separation unit of claim 1, wherein the outlet is configured to be in fluid communication with the input port of the gas monitoring system, and wherein the gas monitoring system is a tape-based gas detector comprising a media element that is configured to change color upon exposure of the media element to the reactive gas present in the filtered fluid.

6. The filter-less particle separation unit of claim 1, wherein the first end of the inlet defines a first aperture and wherein the second end of the inlet defines a second aperture and wherein a diameter of the second aperture is from about 0.7 mm to 1.5 mm and wherein the diameter of the first aperture is from about 5 mm to about 10 mm.

7. The filter-less particle separation unit of claim 1, wherein the defined volumetric flow rate, at which the acceleration nozzle ejects the fluid is within a range from about 700 cc/min to about 1300 cc/min.

8. The filter-less particle separation unit of claim 5, wherein the tape-based gas detector measures a concentration of the reactive gas present in the fluid based on an estimation of a rate of change of the color of the media element.

9. The filter-less particle separation unit of claim 3, further comprising a secondary outlet extending out from the collection probe, the secondary outlet operable to be mechanically engaged to a by-pass flow input port of the gas monitoring system.

10. The filter-less particle separation unit of claim 1, wherein the at least one cavity of the particle separation zone is of the defined form factor that facilitates the inflow of the fluid into the at least one cavity that extends outwardly from the acceleration nozzle and wherein an internal diameter of the cavity is in a range from about 15 mm to about 17 mm.

11. A fluid monitoring system comprising:
a filter-less particle separation unit comprising:
an inlet, operable to facilitate an inflow of fluid including a target gas;
a particle separating zone, comprising at least one cavity having a defined form factor and operable to separate particulate material from the fluid; and
an outlet, operable to outflow filtered fluid including the target gas;
a fluid monitoring chamber configured to measure a concentration of, the target gas that is inflowed from the outlet into the fluid monitoring chamber.

12. The fluid monitoring system of claim 11, wherein the fluid monitoring chamber comprises:
an input port configured to be in fluid communication to the outlet of the filter-less particle separation unit to facilitate an inflow of the filtered fluid into a sub-chamber of the fluid monitoring chamber;
a sensing unit, configured to sense the target gas from the filtered fluid that is inflowed into the sub-chamber of the fluid monitoring chamber; and
a processing unit configured to measure the concentration of the target gas based on the sensing of the target gas by the sensing unit.

13. The fluid monitoring system of claim 11, wherein the particle separating zone is operable to generate a self-cleaning stream pattern of the fluid at a defined volumetric rate to separate out particulate material from the fluid based on at least, an inertia and size of the particulate material.

14. The fluid monitoring system of claim 11, wherein the inlet of the filter-less particle separation unit comprises a first end and a second end defining an annular flow passage operable to facilitate an inflow of the fluid, and wherein the annular flow passage defines an acceleration nozzle between the first end and the second end, that is operable to:
provide an acceleration to the inflow of the fluid in the annular flow passage; and
eject out the fluid within a defined range of volumetric flow rate.

15. The fluid monitoring system of claim 14, wherein the particle separation zone, extends outwardly from the acceleration nozzle and is aligned about a linear axis passing through the inlet and the annular flow passage, and wherein the particle separation zone comprises:
a cavity that extends outwardly from the acceleration nozzle and perpendicular to the linear axis passing through the annular flow passage, wherein the defined form factor of the cavity is operable to:
generate, a self-cleaning stream pattern of the fluid, upon ejection of the fluid from the acceleration nozzle to prevent deposition of the particulate material on an internal surface of the at least one cavity; and
facilitate, the separation of the particulate material from the fluid including the target gas as the fluid flows into the cavity, based on at least inertia and size of the particulate material present in the fluid.

16. The fluid monitoring system of claim 11, further comprising:
a collection probe, operable to collect, the particulate material separated from the fluid; and
a secondary outlet, operable to be in fluid communication to a by-pass flow port of the fluid monitoring chamber.

17. The fluid monitoring system of claim 12, wherein the sensing unit comprises:
a media element configured to change its color, upon exposure of a surface of the media element to the target gas; and
an optical unit comprising an optical sensor, the optical unit configured to:
sense, by the optical sensor, at least one of reflection and transmission of light from the media element with changed color of the surface, upon being exposed to a light of defined wavelength; and
determine, a wavelength of the light, sensed by the optical sensor; and
wherein to measure the concentration of the target gas, the processing unit is configured to:
receive, the determined wavelength of the light sensed by the optical sensor of the optical unit; and
measure the concentration of the target gas from the filtered fluid based on a rate of change of color of the media element that is identified based on processing the determined wavelength of the light.

18. A method for measuring concentration of a target gas in a fluid filtered using a filter-less particle separation unit, the method comprising:
receiving, via an input port of a gas monitoring device and through an outlet of the filter-less particle separating device, an inflow of filtered fluid including the target gas;
determining, by a processing unit, a rate of change of color of a media element of the gas monitoring device, upon exposure of the media element to the filtered fluid including the target gas; and
measuring, by the processing unit, a concentration of the target gas, based on the rate of change of color of the media element of the gas monitoring device.

19. The method of claim 18, wherein the determination of the rate of change of color of the media element comprises:
illuminating, the media element, via a light source upon the exposure of the media element to the filtered fluid;
sensing, via an optical sensor, at least one of a reflection and transmission of light from the media element illuminated by the light source;
determining, a range of wavelength, corresponding to the light sensed by the optical sensor, over a defined time period; and
identifying, colors related to the determined range of wavelength to estimate the rate of change of color of the media element.

20. The method of claim 18, wherein the filter-less particle separating device is configured to generate a self-cleaning stream pattern of the fluid to separate particulate material from the fluid based on virtual impaction using one of a virtual impactor or a vacuum venturi ejector that involves separating the particulate material depending on at least an inertia and size of the particulate material present in the fluid.
